(19) United States
(12) Patent Application Publication
(10) Pub. No.: US 2024/0232815 A1
(43) Pub. Date: Jul. 11, 2024

(54) METHOD, APPARATUS AND NON-TRANSITORY MEDIA TO PROVIDE OPTIONS BASED ON DETERMINING A USER INTENDS TO TRAVEL TO A DESTINATION

(71) Applicant: Capital One Services, LLC, McLean, VA (US)

(72) Inventors: Jennifer Kwok, New York, NY (US); Tyler Maiman, Melville, NY (US); Xiaoguang Zhu, Great Neck, NY (US)

(21) Appl. No.: 18/150,908

(22) Filed: Jan. 6, 2023

(51) Int. Cl. G06Q 10/1093; G06N 20/00; G06Q 20/18

(52) U.S. Cl. CPC G06Q 10/1095; G06N 20/00; G06Q 20/18

(57) ABSTRACT

Methods, apparatuses and non-transitory media are provided for receiving, via a data sharing communication from a map application executing on a mobile computing device, and via an application on the mobile computing device associated with a user, map application data. The map application data may include a destination. The methods, apparatus and non-transitory media may be further provided for determining, by a machine learning model and based on the received map application data, a function that the user intends to perform at the destination, the machine learning model analyzing past user interactions with an entity associated with the destination, and, based on determining the function the user intends to perform, generating a notification, in the application, of one or more options for performing the function.

### FIELD OF USE

Aspects of the disclosure relate generally to a method, apparatus, system and non-transitory media determining that a user is expected to travel to a destination. More specifically, aspects of the disclosure may provide for presenting options to a user determined to be traveling or expected to travel to a destination based on a user's actual or expected intent.

### BACKGROUND

Customers of entities (e.g., banks) often come into branches of the entity to perform traditional banking functions such as depositing a check, withdrawing cash, applying for a loan, opening an account, setting up a Certificate of Deposit, obtaining a cashier's check, applying for a credit card, reporting credit card fraud and others. Also, the customer may go to a destination (e.g., of the financial institution) to perform certain functions including depositing a check and withdrawing cash. The entity in many cases has no way of understanding what function the customer plans to perform at the destination.

A customer visiting entity branch requires use of one or more resources of the entity including, for example, tellers, branch associates and loan officers. Additionally, traveling to a location of an entity may result in carbon emissions and may cause the customer to dedicate more time to complete the function including waiting for an available financial institution representative to become available to assist them.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for a method and apparatus to determine when a customer is traveling or expected to be traveling to a destination (e.g., financial institution branch or ATM) to perform a function. Based on assessing user behavior, a machine learning model may be able to determine what function the user intends to perform and may suggest options for performing the function that may allow the customer to perform the function to, for example, limit the customer's carbon footprint, without going to the destination. Also, the financial institution may be able to do some pre-work in preparation to allow the function to be expedited when the customer arrives at the destination.

A method according to illustrative aspects of the disclosure comprises receiving, via a data sharing communication from a map application executing on a mobile computing device, and via an application on the mobile computing device associated with a user, map application data. The map application data may include a destination. The method may further comprise determining, by a machine learning model and based on the received map application data, a function that the user intends to perform at the destination, the machine learning model analyzing past user interactions with an entity associated with the destination. Further, the method may further comprise, based on determining the function the user intends to perform, generating a notification, in the application, of one or more options for performing the function.

In some aspects, the method may further comprise prior to generating the notification, prompting the user, via at least one of an email, a text message or a push notification, to confirm the determined function prompting the user to identify the function, and receiving user input, based on the prompting, identifying the function. In other aspects, the method may comprise scheduling, in the application and based on the determined function the user intends to perform, one of an appointment for the user with a customer service agent at the destination or an appointment with a customer service agent that is not in-person. In a further aspect, the method may comprise notifying, via at least one of a push notification, an email or a text message, the user of the appointment booked with the customer service agent.

In other aspects, the function may be depositing a check into an account of the user. The option may comprise depositing the check, using the application, into an account of the user. Further aspects may comprise providing the user, via at least one of a push notification, an email or a text message, instructions for depositing the check using the application. A further option may comprise depositing the check, using an ATM, into the account of the user, wherein the map application data further comprises current user location data. In this example, the method may further comprise determining, based on the current user location data, that the destination is not a location, among locations with an ATM, that the user would arrive at the soonest; and instructing the map application, via the application, to reroute the user to the location with an ATM that the user would arrive at the soonest.

In some illustrative aspects, the map application data may comprise current user location data, and the method further comprises determining, by the application, a plurality of travel options for traveling to the destination, and notifying the user of the plurality of travel options. In a further aspect, the plurality of travel options may comprise at least one carbon neutral travel option. In a still further aspect, the method may comprise notifying the user of estimated carbon consumption associated with each of the plurality of travel options.

In another illustrative aspect, the method may comprise storing, prior to receiving the map application data, information related to past interactions the user has had with the entity to form a first dataset and storing, prior to receiving the map application data, a second dataset with information related to past interactions of a plurality of users with the entity. The method may further comprise training a machine learning model using one or more of the first dataset or the second dataset, and storing, prior to receiving the map application data, information related to the most recent interactions the user has had with the entity, wherein determining the function the user intends to perform may be based on correlating the machine learning model with the information related to the most recent interactions the user has had with the entity.

Corresponding method, apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an illustrative system in which aspects of the disclosure may be implemented;

FIG. 3 depicts an illustrative process for implementing one or more aspects of the disclosure in accordance with one or more illustrative aspects discussed herein;

FIG. 4 depicts an illustrative process for determining what function a user intends to perform in accordance with one or more illustrative aspects of the disclosure;

FIG. 5 depicts an illustrative process for implementing a machine learning model according to one or more illustrative aspects of the disclosure;

FIG. 6 depicts an illustrative display interface of a computing device in accordance with one or more illustrative aspects of the disclosure; and

FIG. 7 depicts another illustrative display interface of a computing device in accordance with one or more illustrative aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to a method, apparatus, system and non-transitory media that may determine a user intends to travel to a destination (e.g., financial institution or an automated teller machine (ATM)) to perform a function (e.g., traditional banking function) and provides the user with various options for realizing the function, which may result in reducing one or more of the user's carbon footprint, the amount of time the user spends (including wait time) to perform the function, and the amount of resources that destination entity uses to help the user perform the function.

Some traditional banking functions can be performed without the customer having to travel to the financial institution or an ATM while conserving time and limiting emissions of greenhouse gases. Other functions may be streamlined if the financial institution were aware of the function that the customer was intending to perform. It would be advantageous if the financial institution were able to anticipate what the customer was planning to do.

Certain aspects of the disclosure may attempt to improve the customer experience by reducing the amount of time required for the customer to perform the desired function. Other aspects of the disclosure may attempt to reduce the carbon footprint of the customer in performing the desired function. Some aspects may attempt to reduce the amount of resources that the destination entity uses to perform the customer desired function. In other aspects, more than one of these benefits may be realized.

In some aspects of the disclosure, the entity may advise the customer (e.g., via text, email, push notification via financial institution application, etc.) that the desired function could be performed online or via the entity application (“app”) and provide the customer the option to do so and not travel to the destination as the user originally intended. Alternatively, with knowledge of the function that the user intends to perform, the entity may be able to prepare for the customer by obtaining certain information in advance from the customer or from records (e.g., bank record), for example, information needed to apply for a service (e.g., loan). This may result in time savings for both the user and the entity.

In some aspects, the app may integrate with a map app through an API or another data sharing technique. The app may receive the map app data and detect if the user is planning to travel to a destination. Upon detecting that a user is going to the destination, the system may attempt to detect the function for which the user intends to visit the destination by, for example, prompting the user (e.g., via the app) as to what function she intends to perform at the destination. For some users, the entity may employ a machine learning model to anticipate what function the user intends to perform at the destination based on, for example, at least one of the user's recent interactions with the entity (e.g., online behavior, call center logs, previous visits to the entity etc.) and interactions of previous users. Options based on anticipated or user provided intent may include booking an appointment (in-person or not in-person) with a representative or agent, reminding user that function (in the case of certain functions) can be executed via the app without traveling to the destination; initiating or scheduling a user service call or online chat with a customer service agent; and suggesting greener alternatives than the user driving to the destination (e.g., public transportation, bicycle, walking).

While the method and techniques disclosed herein apply to a service oriented environment, one of ordinary skill will appreciate that some aspects may be described in connection with a financial institution environment, the invention is not so limited may be applied to other environments such as other service oriented environments.

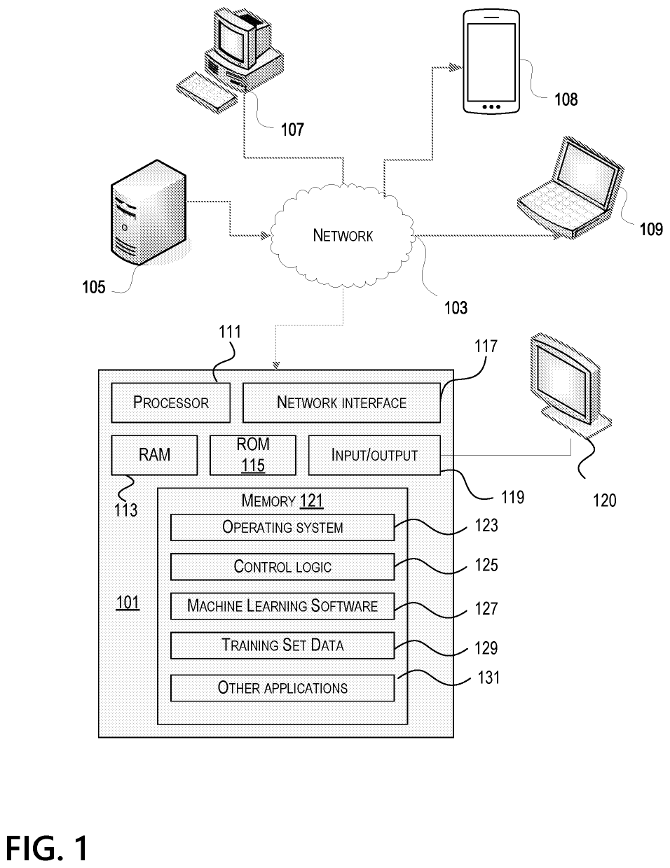

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smartphone, any other types of mobile computing devices, and the like), and/or any other type of data processing device.

Computing device 101 may, in at least some aspects, operate in a networked environment. As shown in FIG. 1, various network nodes 101, 105, 107, 108, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 108, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces (I/O) 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 108, 109 may have similar or different architecture as described with respect to computing device 101. Those of skill in the art will appreciate that the functionality of computing device 101 (or devices 105, 107, 108, 109) as described herein may be spread across multiple data processing devices, for example, to distribute processing load across multiple computers, to segregate transactions based on geographic location, user access level, quality of service (QOS), etc. For example, devices 101, 105, 107, 108, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

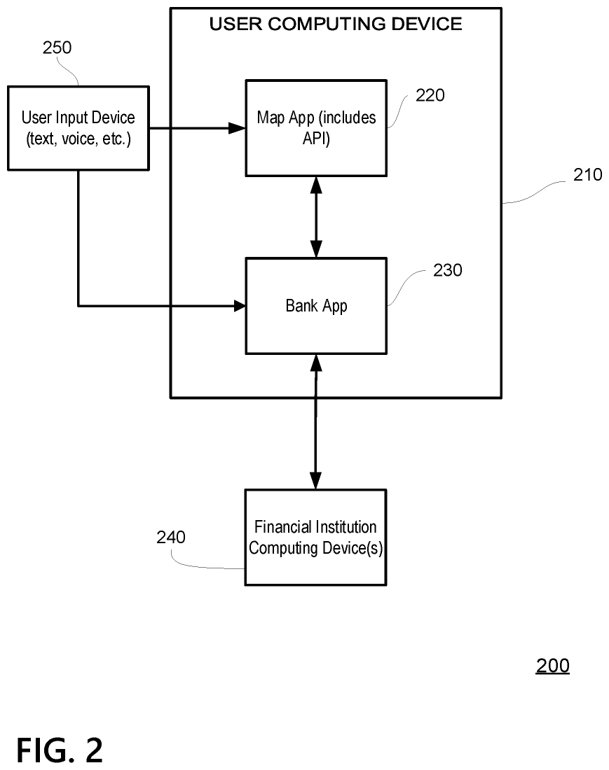

FIG. 2 shows an illustrative system 200 implementing aspects of the disclosure including a user computing device 210. The user computing device 210 may be a mobile computing device like devices 108 and 109 (e.g., a laptop computer, a tablet computer, a smartphone, and the like) including other applications 131 in FIG. 1. The user computing device 210 may have stored thereon applications (“apps”) including, among the other applications 131, a map app 220 and a bank app 230. The bank app 230 may communicate with a remote financial institution computing device(s) 240, which is similar to, for example, computing device 101 in FIG. 1. The bank app 230 may be integrated with the map app 220 such that the apps may share data with each other, for example via one more APIs or other data sharing techniques. A user may input data using user input device 250 (e.g., microphone, keyboard, camera, touchpad, etc.), via voice, text, gesturing or other known methods of inputting data into computing devices, to the map app 220, bank app 230 and other apps stored on the user computing device 210. It will be appreciated that the user may need to set the appropriate permissions in a settings application on the user computing device 210 to enable location services (e.g., current GPS data), data services and sharing of information from the map app 220 and the bank app 230.

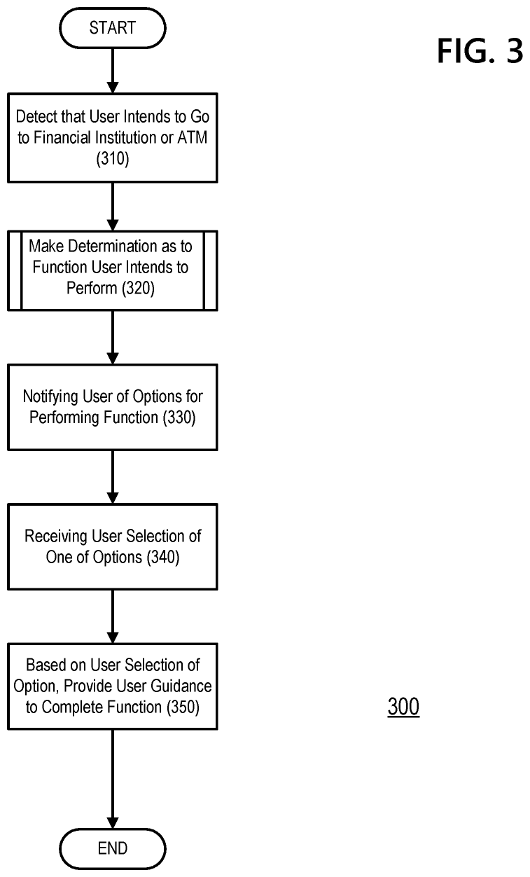

FIG. 3 provides an example process 300 for providing options based on determining that a user intends to travel to a destination, which in this example may be a financial institution or ATM, to perform a function according to aspects of the disclosure. In some aspects of the disclosure, the user may be planning to travel to the financial institution or ATM while in other aspects the user may be in the process of traveling to a financial institution or ATM.

For purposes of this disclosure, the financial institution may be a bank, a branch location, a customer service center, a bank café or other location at which a user may perform banking services. These terms may be used interchangeably in the examples provided herein. According to some aspects, the user will be a bank customer who has some type of account with the bank (e.g., checking, savings, mortgage, credit card, etc.). As such, the term “customer” rather than “user” may be used in many examples described in the disclosure, but it should be understood that the use of the term customer is not intended to be limiting and the description may apply to users who are not current bank customers.

A customer of a financial institution may have the bank app 230 installed on their computing device 200, such as a mobile computing device like devices 108 and 109 (e.g., a laptop computer, a tablet computer, a smartphone, and the like). In step 310, the financial institution computing device(s) 240 may detect that a user intends to go to the financial institution or an ATM. This may occur when a customer provides an input query or command via user input device 250 to the map app 220 (e.g., Google Maps®, Apple Maps®, Waze® and the like) to search for a location or to obtain directions from a location (e.g., current user location) to a destination. The map app 220 may perform the query or command and via data sharing make available data including, but not limited to, the location or destination input by the user, various routes to the destination from the user's current location or a user entered location and directions for various modes of traveling to the destination including the estimated time it will take based on the traveling mode.

According to one illustrative implementation, the bank app 230 may make frequent API function calls to an API of the map app 220 for data including, for example, the aforementioned data types. In response to a function call, the map app 220 may send new data (e.g., since the last function call) to the bank app 230 where it may be parsed and examined. The bank app 230 may determine whether the data identifies any information that may suggest the user intends to perform a banking function. Such data may include, for example, one or more of the bank name, an ATM, a bank address, or a term associated with a bank, bank function or ATM. In an illustrative example, the bank app 230 may include, or access via the financial institution computing device(s) 240, a library of banking related data and perform a fuzzy comparison of the data received from the map app 220 with data stored in the library to determine whether any of the received data might suggest that the user intends to go to a financial institution or ATM. If the data suggests that the user intends to go to a financial institution or ATM, then in step 310 the user computing device 210 may detect that a user intends to go to a financial institution or ATM.

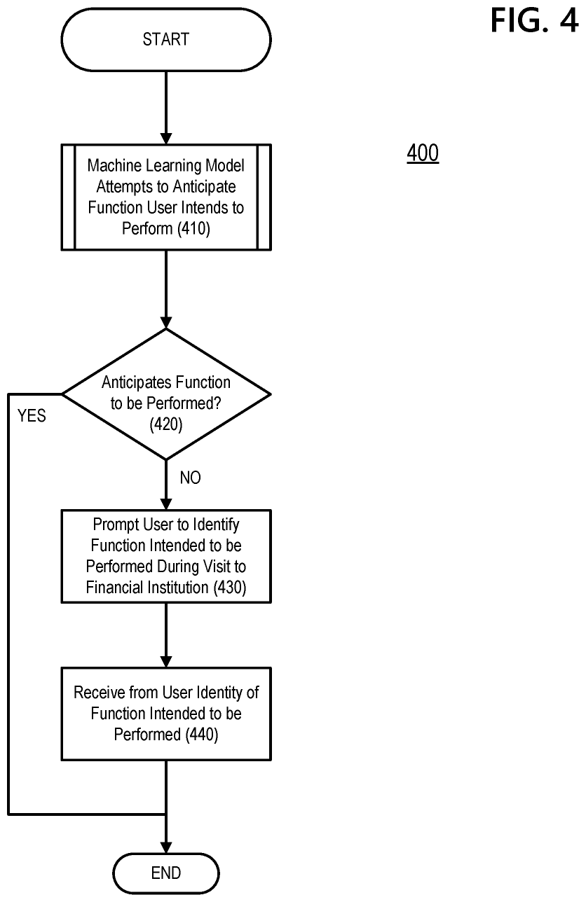

After detecting that a user intends to go to a financial institution or ATM in step 310, in step 320 the process of determining what function the user intends to perform at the financial institution or ATM may be executed. FIG. 4 provides an example process 400 for determining what function a user intends to perform in step 320 according to illustrative aspects of the disclosure.

In step 410, a machine learning model process may attempt to anticipate the function the user intends to perform by visiting the financial institution or ATM. In this case, the bank app 230 may send, to one or more financial institution computing devices 240, data identifying the user intending to visit the financial institution or ATM and data indicating the location (e.g., address) of the branch or ATM the user intends to visit. The financial institution computing device(s) 240 may execute such a machine learning process using a machine learning model such as machine learning software 127 in computing device 101. Machine learning software 127 may use various machine learning models and/or algorithms, such as, but not limited to, supervised learning algorithms, unsupervised learning algorithms, regression algorithms (e.g., linear regression, logistic regression, etc.), instance based algorithms (e.g., learning vector quantization, locally weighted learning, etc.), regularization algorithms (e.g., ridge regression, least-angle regression, etc.), decision tree algorithms, Bayesian algorithms, clustering algorithms, artificial neural network algorithms, classification algorithms, ranking algorithms, etc.

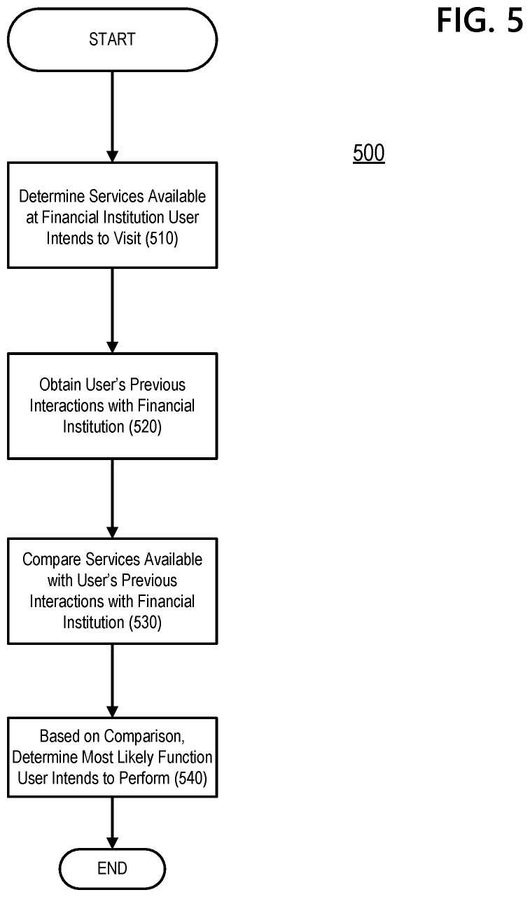

An example machine learning process 500 is shown in FIG. 5 and will be discussed with respect to a case in which the intended user destination is determined to be a bank branch. It will be appreciated that a similar process may be executed when the intended user destination is determined to be an ATM. The machine learning process 500 may determine the services available at the bank branch the user intends to visit in step 510. The financial institution computing device(s) 240 may include a bank branch database which stores the various services available at each bank branch. The financial institution computing device(s) 240 may use the bank branch location data to access the database to determine the services available at the bank branch.

Next or prior to step 510, in step 520, using the identity of the user, the user's previous behavior such as interactions with the financial institution may be obtained. For example, the financial institution computing device(s) 240 may contain a detailed record in a customer database of the interactions a customer has had with the financial institution over a period of time (e.g., since account inception, or for a defined term like one month, one year, etc.). Interactions may include, but are not limited to, calls with customer service agents where call center logs exist that document at least some calls, online activity including online chats with customer agents, online page views and searching in the bank app 230 where the search strings and page views may be stored in the customer record, online communications including email with the financial institution, online form submissions to the financial institution, partially filled out online financial institution related forms (e.g., credit card application, account application, loan application, fraud report, lost debit or credit card report), failed online banking transactions, or activities performed at an ATM or bank branch location. It will be appreciated that any interaction which the financial institution can track may be included in the customer database.

Subsequently, in step 530 the financial institution computing device(s) 240 may apply the machine learning models to compare the user's previous interactions with the financial institution with the services available at the financial institution the user intends to visit and data including the available functions at the bank branch location and functions performed based on similar past interactions. The comparison may or may not be limited to comparing the more recent interactions such as over the previous month(s) or year, or the last 100 interactions. The machine learning model may assign a greater weight to the most recent interactions (e.g., the last five interactions, the interactions over the last week) in trying to determine which function the customer most likely intends to perform.

Based on the results of the comparison in step 530, the machine learning model may determine the most likely function the user intends to perform at the financial institution in step 540. The machine learning model may determine the degree of correlation between the functions in the model and the current user interactions. Each possible function, based on the degree of correlation, may be assigned a confidence score based on the likelihood that the user intends to perform the function. The score may be determined by examining similar prior behaviors by the user and what function the user ultimately performed. Also, the machine learning model in determining the score for each function may consider what functions other similarly situated users sought to perform when their interactions with the financial institution were similar to the current user.

For training the machine learning model, the machine learning software 127 may maintain a custom training dataset associated with the specific user and the likelihood of a function being sought out based on a series of interactions and a generic training dataset associated with a group of users and the likelihood of a function being sought out based on a series of interactions. For users who have performed a series of functions and who have a significant track record, the custom training dataset may be used to train the machine learning model. In the event that the user has not performed a number of functions previously (e.g., at least five) such that the custom training dataset does not have sufficient data to allow the machine learning model to determine a most likely function, the generic training dataset may be used to train the machine learning model. This may allow the machine learning model to correlate the current user's interactions and available functions to determine a score for the available functions. In another example, the machine learning model may determine it has sufficient data to perform an analysis, but the results may be indeterminate as to what function the user intends to perform. For example, when applying the machine learning model, it is possible that no score exceeds a threshold score needed for the machine learning model to make a determination. In this instance, the generic training dataset alone or in combination with the custom training dataset may be used to train the machine learning model to determine the most likely function. When using both the custom training dataset and the generic dataset to train the machine learning model, the machine learning model may assign different weightings to the scores obtained based on being trained by each dataset and combine them to determine an overall score to determine the most likely function.

The machine learning software 127 may generate additional training datasets to input to the machine learning models to train the models to make other predictions or to recognize other data for use in determining a user intended function. For example, the machine learning models may be trained with a training dataset for a bank branch, an ATM, bank branches in a particular geographic region, etc. to train the model to recognize language in customer interactions that may be indicative of user intended functions likely for those particular destinations.

If the machine learning model is able to determine a most likely function, the financial institution computing device(s) 240 may return that result to the bank app 230 and the process 400 of determining what function a user intends to perform may continue in step 420. In some instances, if the machine learning model is unable to determine a most likely function, the financial institution computing device(s) 240 may return the result that no function was determined to the bank app 230 and the process 400 of determining what function a user intends to perform may continue in step 420. The machine learning model may not be able to determine a most likely function due to, for example, no function having a score high enough to exceed a threshold value (e.g., 65 on a 100-point score system). This may be the result of not having sufficient data.

In step 420, the bank app 230 may determine whether the machine learning process 400 was able to anticipate the function that the user intends to perform by visiting the financial institution or ATM. The bank app 230 may evaluate the results received from the machine learning process. If the function has been correctly anticipated (420: YES), then the process 400 of determining what function a user intends to perform may return the result to step 330 in FIG. 3. If the function has not been anticipated (420: NO), then the process 400 may continue in step 430. The result that the function was not correctly anticipated based on the associated user interactions with the financial institution may be added to the custom training dataset and the generic training dataset stored in the financial institution computing device(s) 240 to provide more data for the machine learning model for future users.

In step 430, the bank app 230 may prompt the user to identify the function that they would like to perform. The bank app 230 may present a push notification to the user and request the user to respond with the function they intend to perform. In some instances, the bank app 230 may cause the financial institution computing device(s) 240 to send a text and/or email to the user requesting the user to identify the function that they would like to perform. It will be appreciated that the bank app 230 or the financial institution computing device(s) 240 may prompt the user via push notification, text, email, etc.

In step 440, the bank app 230 or the financial institution computing device(s) 240 may receive from the user the identity of the function that they intend to perform during their visit to the financial institution or ATM. The user may respond to the prompts of the bank app 230 or the financial institution computing device(s) 240 and identify the function that they intend to perform via, for example input to the bank app 230, text or email. Then, the process 400 of determining what function a user intends to perform may return the result to step 330 in FIG. 3. Also, the function the user identified and the associated user interactions with the financial institution may be added to the custom training dataset and the generic training dataset stored in the financial institution computing device(s) 240 to provide more data for the machine learning model for future determinations.

In some aspects, the bank app 230 may determine that there is insufficient information to allow the machine learning model to anticipate the function the user intends to perform. That is, the bank app 230 in step 320 may determine that the machine learning model will not be able to anticipate the function the user intends to perform in step 410 before attempting to have the machine learning model do so. The bank app 230 may make such a determination with a new customer based on the age of their account(s) or due to a general paucity of transactions carried out by the user. In this case, steps 410 and 420 may be skipped and the process may go directly to step 430 to prompt the user to identify the function they intend to perform.

After determining the function the user intends to perform in step 320, the bank app 230 may provide the user with a list of options for performing the function in step 330. For example, the list of options may be provided on the display interface of the user computing device 210 in the bank app 230. The user may be notified of the list via a push notification, text, email, etc. The list may be received from the financial institution computing device(s) 240 (e.g., remote servers) or the bank app 230 may be able to locally access and display the list of options. The financial institution computing device(s) 240 may receive the anticipated or actual function the user intends to perform from the bank app 230 in a case that the financial institution computing device(s) 240 performs the process of determining the function in step 320.

If the machine learning process is able to identify an anticipated function, prior to notifying the user of the options for performing the function, the process 300 may confirm with the user that the anticipated function is correct by sending a message asking the user to confirm that the function is correct. An illustrative message may be sent via a push notification from the bank app 230, text or email to the user requesting the user to confirm the anticipated function. In this example, once the user confirms the anticipated function, then the user may be notified of the options for performing the function in step 330. If the user indicates that the anticipated function is incorrect, then steps 430 and 440 may be executed to identify the correct function. Thereafter, step 330 may be implemented. Whether the function has been correctly or incorrectly anticipated, the confirmation result including the function anticipated and the associated user interactions with the financial institution may be added to the custom training dataset and the generic training dataset stored in the financial institution computing device(s) 240 to allow the machine learning model to adjust based on the updated data.

In step 340, the user computing device 210 may receive a user selection of one of the options via user input device 250. For example, if the options are provided on the display interface, the user may interact (e.g., via keyboard or keypad) with the display interface to select the desired option. Alternatively, the user may be able to provide a voice command to select the desired option.

In step 350, the bank app 230, based on the selected option, may provide the user with the appropriate guidance to complete the function. That is, the selected option may cause a database to be examined for further information to pull information to be provided to the user (e.g., via the display). Such guidance may include, but is not limited to, providing further display screens as necessary to provide the user with instructions and allow the user to enter any necessary data. For example, if the user intends to apply for a loan using an online application, the user may be presented with the appropriate content via a web page. Likewise, if a chat, call or in-person appointment needs to be set up and scheduled, an appropriate display screen(s) may be provided to the user to set up and schedule their activity. In another example, if the user intends to deposit a check and has selected the option to make a mobile deposit, a tutorial for how to perform a mobile deposit may be provided.

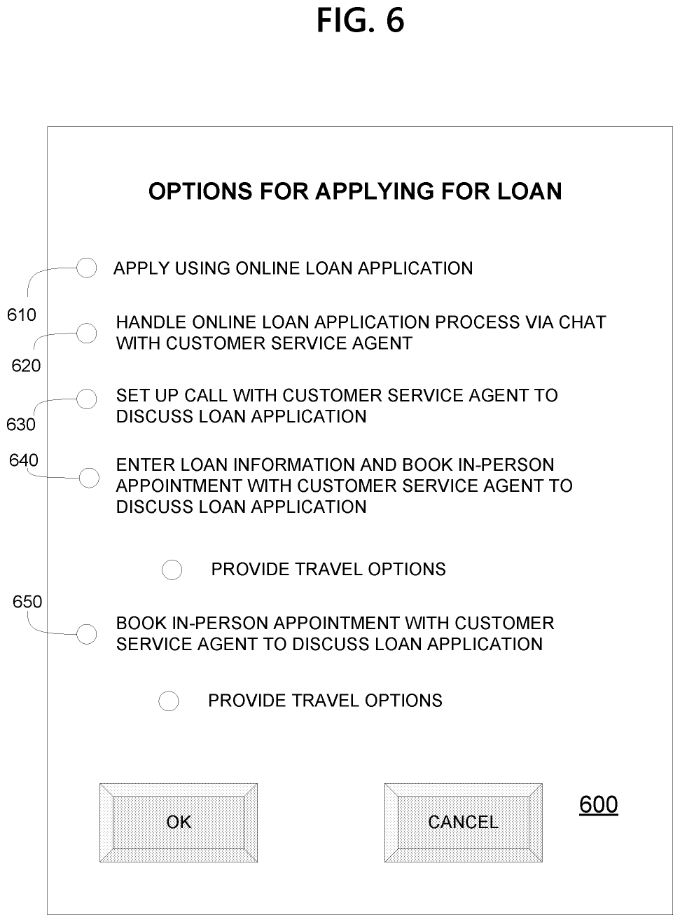

FIG. 6 depicts an illustrative display interface 600 of the user computing device 210 (e.g., mobile computing device) which may be provided to the user with an example list of options when the function is determined to be applying for a loan. In this example, five options are provided which may be selected by the user via the radio buttons 610, 620, 630, 640, and 650 on the display interface 600. The options for applying for a loan may include: 1) apply using online loan application; 2) handle online loan application process via chat (text or video) with a customer service agent; 3) set up call with customer to service agent to discuss/complete loan application; 4) enter certain loan information online and book in-person appointment with customer service agent to discuss/complete loan application; and 5) book in-person appointment with customer service agent to discuss/complete loan application. To select one of the options, the customer may select the radio button corresponding to the option they desire and then select the “OK” button. To cancel, the customer can select the “CANCEL” button.

Each of these illustrative options may result in streamlining the loan application process for the customer. For example, the first three options may allow the customer to apply for a loan without physically having to travel to the bank, which not only may save the customer time, but also may reduce possible carbon emissions in the event the customer were to travel to the bank by, for example, automobile, rideshare, bus, train, or light rail. That is, the first three options may be eco-friendly.

The fourth option may allow a user to save time by entering loan information online before traveling to the bank. The fourth and fifth options, by booking an appointment, may allow the user to avoid having to wait a long time for an available customer service agent when they arrive at the bank. The first three options may result in benefits for the bank. For example, the customer service agents may be at remote locations not at a physical branch and allow for more efficient use of bank resources (customer service agents). The fourth option, by having the customer enter information related to the function they intend to perform, also may result in a more efficient process from the bank perspective.

With other actual or anticipated functions, similar options may be provided. For example, the option to book an appointment with a customer service agent may be available for other banking functions where the customer has chosen to travel to the bank. Also, some financial institutions, in addition to banking functions, may provide other services such as a café. In these instances, the customer may be presented with an option to pre-order food or a beverage such as a coffee for their scheduled visit. In an example where the customer is going to an ATM or bank to deposit a check, a customer may be reminded that a check deposit may be made via the bank app 230 on, for example, a mobile computing device such as mobile phone, and provide the customer the directions to deposit a check via a push notification via the bank app 230. In other aspects, the directions may be texted or emailed to the customer.

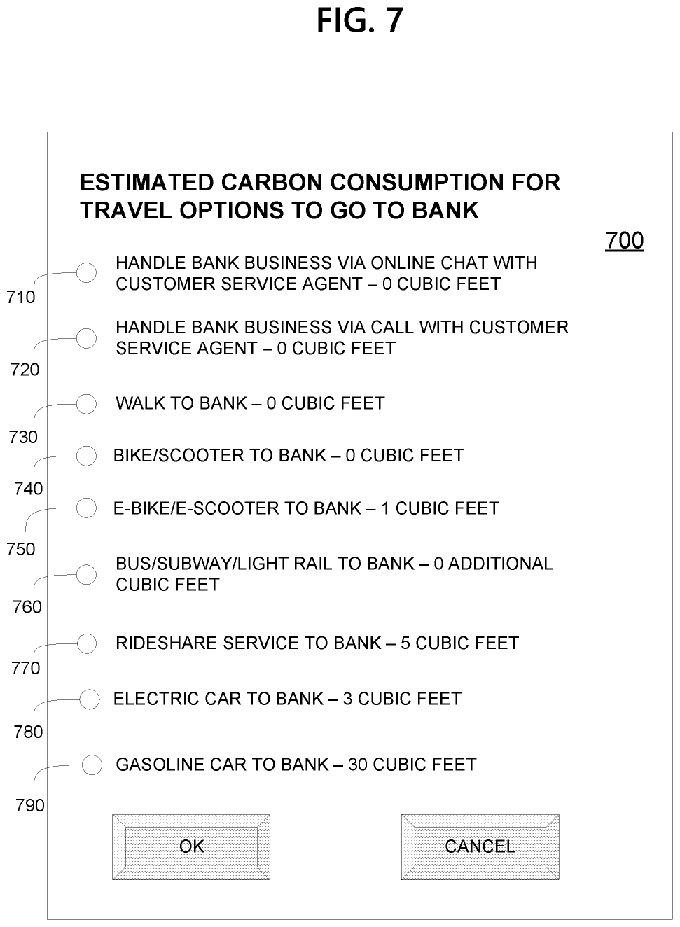

In a further aspect, an option may be provided to suggest travel mode alternatives for traveling to the ATM or bank. As illustrated in FIG. 6, the two options which require travel to the bank including booking an in-person appointment have a sub-alternative portion in which the customer can decide whether to review travel options. One of the goals by providing travel options is to encourage the customer to consider more eco-friendly options for traveling to the bank. If either radio button 640 or 650 is selected, the provided travel options may be available for the customer to select to obtain alternative travel modes to the bank branch. If the customer selects, in addition to one of the radio buttons 640 or 650, the corresponding travel options radio button and presses the OK button, the illustrative display interface in FIG. 7 may be rendered on the user computing device 210.

In one illustrative aspect, the bank app 230, upon receiving a user selection to suggest travel alternative modes, may confirm that the closest bank branch of the financial institution, which provides the anticipated function the customer wants to perform, to the customer's current location is the destination received from the API of the map app 220. If the destination received from the API of the map app 220 is not the closest bank branch location to the customer's current location (or provided originating location from which directions were requested by the user), the bank app 230 may provide the user with the identity of each closer branch location and the estimated time to travel to the closer branch location(s). The bank app 230 may obtain the closer branch location information from bank branch search functionality provided in the bank app 230. Also, the bank app 230 may cause the map app 220 to search for the closest branch location and provide the user with the option to select the closest branch location as the destination. The bank app 230 may make a call to an API of the map app 220 to obtain the travel options and associated information including distance, time and carbon consumption for traveling by each travel mode. In a case where the map app 220 does not provide carbon consumption information, the bank app 230 may access a database in the app or in the financial institution computing device(s) 240 to obtain the carbon consumption information.

Likewise, similar actions can be performed for an ATM. Oftentimes, the customer may not recall that they are able to conduct ATM transactions with ATMs not affiliated with the financial institution. Further, the customer may not identify or search for other ATMs unaffiliated with the financial institution. Thus, the closest ATM to the customer for performing their desired function is frequently not the location of the ATM identified by the customer. The bank app 230 may obtain the closest ATM location similarly to how the closest branch location is obtained as described above.

FIG. 7 depicts an illustrative display interface 700 of the user computing device 210 (e.g., mobile computing device) which may be provided to the user with an example list of travel options to travel to a bank (or ATM) and the estimated carbon consumption associated with each option. Additionally, other information such as the distance and estimated travel time to the destination for each option may be provided as part of the display interface 700. In a case where the map app 220 does not provide carbon consumption information (e.g., it is not available), the bank app 230 may determine the estimated carbon consumption or have the financial institution computing device(s) 240 determine the carbon consumption information. In this case, the bank app 230 or the financial institution computing device(s) 240 may take the travel mode, distance and estimated time to travel to the destination and apply a formula based on those three parameters to calculate the estimate carbon consumption which may then ultimately be displayed on the display interface 700 with the corresponding travel option.

In this example, nine options are provided which may be selected via the radio buttons 710-790 on the display interface 700. FIG. 7 provides illustrative travel options for traveling to a bank branch according to some aspects of the disclosure. The options may include: 1) handle bank business via online chat with customer service agent; 2) handle bank business via call with customer service agent; 3) walk to bank; 4) bike/scooter to bank; 5) e-bike/e-scooter to bank; 6) bus/subway/light rail to bank; 7) rideshare to bank; 8) electric car to bank; and 9) gasoline car to bank. The travel options provided in FIG. 7 are illustrative and less or more travel options may be included such as motorcycle to bank, take hybrid vehicle to bank, etc. To select one of the options, the customer may select the radio button corresponding to the option they desire and then select the “OK” button. To cancel, the customer can select the “CANCEL” button. In the case that the customer plans to travel to an ATM, travel options for traveling to the ATM may be provided some of which may be the same as or similar to the options provided in for traveling to a bank in FIG. 7. If the customer selects a travel option such as public transportation, a push notification could be sent providing the customer with information about the mode of transportation including, for example, a bus or train schedule, an identity of the closest stop or station and the like. Selection of the travel option in some aspects may cause the travel route selected by the selected travel mode to be displayed. For example, the map app 220 may display the travel route on the display interface of the user computing device 210.

In another illustrative aspect such as the example illustrated in FIG. 6, the display interface 600 may not include the option for the customer to request travel options. According to one aspect, once the bank app 230 has received the customer selection of an option that involves the customer traveling to the financial institution or ATM, the bank app 230 may obtain from the map app 220 data for various travel modes by which the customer may travel to the financial institution. Then, the bank app 230 may send a push notification to the customer providing a list of travel options similar to FIG. 7 with, for example, the travel mode, the distance to travel by that mode, the estimated time to travel by that mode, and the estimated carbon emissions associated with the particular travel mode. Additionally, the push notification can encourage the customer to select a carbon neutral travel mode such as walking or biking. Alternatively, the bank app 230 may cause the map app 220 to send the push notification to the customer providing the list of travel options and the map directions for travel using each option. In still another alternative, a customer may, after having previously selected a travel option, update travel options to their intended destination, based on the customer's current location.

The travel options presented may vary based on location of the bank branch. For example, certain types of public transportation may not be available in suburban locations. If the desired location is more than a threshold distance (e.g., 15 miles) from the originating location or the user's current location (and the user has not identified another originating location) or a threshold amount of time to travel to the destination exceeds a threshold (e.g., 2 hours), travel options such as the walk option may not be provided to the user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving, via a data sharing communication from a map application executing on a mobile computing device, and via an application on the mobile computing device associated with a user, map application data;
determining, by a machine learning model and based on the received map application data, a function that the user intends to perform at a destination, the machine learning model analyzing past user interactions with an entity associated with the destination; and
based on determining the function the user intends to perform, generating a notification, in the application, of one or more options for performing the function.

2. The method of claim 1, further comprising:
prior to generating the notification, prompting the user, via at least one of an email, a text message or a push notification, to confirm the determined function, and
receiving user input, based on the prompting, confirming the determined function.

3. The method of claim 1, further comprising:
scheduling, in the application and based on the determined function the user intends to perform, one of an appointment for the user with a customer service agent at the destination or an appointment with a customer service agent that is not in-person; and
based on scheduling the appointment, generating a notification, in the application, to notify the user of the appointment.

4. The method of claim 1, wherein the function is depositing a check into an account of the user, and an option comprises depositing the check, using the application, into the account of the user, and
wherein the method further comprises:
providing the user, via the application, instructions for depositing the check using the application.

5. The method of claim 4, wherein another option comprises depositing the check, using an ATM, into the account of the user,
wherein the map application data further comprises current user location data, and
wherein the method further comprises:
determining, by the application and based on the current user location data, that the destination is not a location, among locations with an ATM, that the user would arrive at the soonest; and
instructing the map application, via the application, to reroute the user to the location with an ATM that the user would arrive at the soonest.

6. The method of claim 1, wherein the map application data comprises current user location data, and the method further comprises:
determining a plurality of travel options for traveling to the destination, and
notifying the user of the plurality of travel options.

7. The method of claim 6, wherein the plurality of travel options comprises at least one carbon neutral travel option.

8. The method of claim 6, further comprising:
determining, for the plurality of travel options, estimated carbon consumption for travelling to the destination; and
notifying the user of the estimated carbon consumption associated with the plurality of travel options.

9. The method of claim 1, further comprising:
storing, prior to receiving the map application data, information related to past interactions the user has had with the entity to form a first dataset;
storing, prior to receiving the map application data, a second dataset with information related to past interactions of a plurality of users with the entity;
training the machine learning model using one or more of the first dataset or the second dataset; and
storing, prior to receiving the map application data, information related to the most recent interactions the user has had with the entity,
wherein determining the function the user intends to perform is based on correlating the machine learning model with the information related to the most recent interactions the user has had with the entity.

10. One or more non-transitory media storing instructions that, when executed by one or more processors, cause the one or more processors to perform steps comprising:
receiving, via a data sharing communication from a map application executing on a mobile computing device of a user, and via an application on the mobile computing device and associated with an entity, map application data comprising a destination;
determining, by a machine learning model and based on the received map application data and past interactions of a plurality of users with an entity associated with the destination, a function the user intends to perform at the destination; and
based on determining the function the user intends to perform, sending, to the user, a notification of one or more options for performing the function.

11. The one or more non-transitory media according to claim 10, wherein sending the notification comprises messaging the user via at least one of a push notification, an email or a text message.

12. The one or more non-transitory media of claim 10, wherein the instructions further cause the one or more processors to perform the steps of:
prior to sending the notification, prompting the user to confirm the determined function, and
receiving user input, based on the prompting, confirming the determined function.

13. The one or more non-transitory media of claim 10, wherein the instructions further cause the one or more processors to perform the step of:
scheduling, based on the function the user intends to perform, an appointment for the user with a customer service agent at the destination.

14. The one or more non-transitory media of claim 10, wherein the instructions further cause the one or more processors to perform the step of:
scheduling, based on the function the user intends to perform, an appointment with a customer service agent that is not in-person; and
based on scheduling the appointment, generating a notification to notify the user of the appointment.

15. The one or more non-transitory media of claim 14, wherein the instructions further cause the one or more processors to perform the step of:
recommending to the user, based on the function the user intends to perform, to schedule a time for the appointment with a customer service agent that is not in-person,
wherein the scheduling is further based on receiving a scheduled time for the appointment from the user.

16. The one or more non-transitory media of claim 10, wherein the function is depositing a check into an account of the user, and an option comprises depositing the check, using the application, into the account of the user, and
wherein the instructions further cause the one or more processors to perform the step of:
providing the user with instructions for depositing the check.

17. The one or more non-transitory media of claim 10, wherein the map application data comprises current user location data, and the instructions further cause the one or more processors to perform the steps of:
determining a plurality of travel options for traveling to the destination;
determining, for the plurality of travel options, estimated carbon consumption for travelling to the destination; and
notifying the user of the plurality of travel options and the estimated carbon consumption associated with the plurality of travel options.

18. The one or more non-transitory media of claim 17, wherein the plurality of travel options comprises at least one carbon neutral travel option.

19. The one or more non-transitory media of claim 10, wherein the instructions further cause the one or more processors to perform the steps of:
storing, prior to receiving the map application data, information related to past interactions the user has had with the entity to form a first dataset;
storing, prior to receiving the map application data, a second dataset with information related to past interactions of a plurality of users with the entity;
training the machine learning model using one or more of the first dataset or the second dataset; and
storing, prior to receiving the map application data, information related to the most recent interactions the user has had with the entity,
wherein determining the function the user intends to perform is based on correlating the machine learning model with the information related to the most recent interactions the user has had with the entity.

20. An apparatus, comprising:
one or more processors; and
memory storing instructions that, when executed by the one or more processors, cause the apparatus to:
receive, via a data sharing communication from a map application executing on a mobile computing device associated with a user, via an application on the mobile computing device and associated with an entity, map application data comprising a destination associated with an entity;
determine, by a machine learning model and based on the received map application data and past interactions of at least one user with the entity, a function the user intends to perform at the destination; and
based on determining the function the user intends to perform, sending, to the user, one or more options for performing the function without travelling to the destination.
